(19) United States
(12) Patent Application Publication
(10) Pub. No.: US 2017/0308129 A1
(43) Pub. Date: Oct. 26, 2017

(54) KEYBOARD WITH KEY ACCOMMODATION FUNCTION

(71) Applicant: PRIMAX ELECTRONICS LTD., Taipei (TW)

(72) Inventor: Che-Wei Yang, Taipei (TW)

(21) Appl. No.: 15/193,360

(22) Filed: Jun. 27, 2016

(30) Foreign Application Priority Data
Apr. 22, 2016 (TW) 105112634

(51) Int. Cl. G06F 1/16

(52) U.S. Cl. CPC G06F 1/1666

(57) ABSTRACT

A keyboard with a key accommodation function is provided, including: a keyboard base body, a plurality of keys, and a flexible rollable panel. The flexible rollable panel and the keys are adjacently disposed on the keyboard base body. The flexible rollable panel includes a panel surface, and a free end portion jointly disposed at one side of the panel surface. Each of the keys has a first matching surface, and the free end portion has a second matching surface. When the flexible rollable panel is unfolded, the second matching surface of the free end portion sequentially abuts against the first matching surfaces of the keys, so that each of the first matching surface is pressed downwards because each of the first matching surface is subjected to a downward vertical component from the second matching surface, thereby unfolding the panel surface above the keys, and reducing space occupied by the keys.

### FIELD OF THE INVENTION

The present invention relates to a keyboard, and more particularly to a keyboard with a key accommodation function.

### BACKGROUND OF THE INVENTION

Keyboards are indispensable devices when modern people use computers. Many keys are provided on a keyboard, so that a user presses the keys to input an instruction. Traditional keyboards have many key designs for generating key signals. For example, a mechanical key triggers a circuit switch by using a conductive pin, so as to generate a key trigger signal, and in an optical key design, a key trigger signal is generated by using a change of receiving lights or blocking lights.

However, with regard to a mechanical key or an optical key, a key press travel is necessarily designed in a press structure of the mechanical key or the optical key. Therefore, before the mechanical/optical key is pressed, the key is ejected upwardly and therefore is protruded from a keyboard surface. In other words, a traditional keyboard has a particular thickness. If a notebook computer is provided with a keyboard of such kind, after a screen of the notebook computer is closed, the thickness of the notebook computer is a sum of the thickness of a traditional keyboard and the thickness of the screen, and the thinness of the notebook computer cannot be achieved. Therefore, conventional keyboards still need to be improved.

### SUMMARY OF THE INVENTION

A main objective of the present invention is to provide a keyboard with a key accommodation function. By actuating a flexible rollable panel to sequentially abut against keys on a keyboard during a travelling process of the flexible rollable panel, the keys on the keyboard are pressed downwards, so as to reduce heights of the keys and achieve an accommodation effect.

In accordance with a preferred implementation concept of the present invention, there is provided a keyboard with a key accommodation function, including:

a keyboard base body, having a key arrangement area and a flexible rollable panel arrangement area, where the key arrangement area is adjacent to the flexible rollable panel arrangement area;

a plurality of keys, disposed in the key arrangement area, where each of the keys has a key cap, and a top edge of each key cap has a first matching surface; and

a flexible rollable panel, including:
a connection end portion, located at the flexible rollable panel arrangement area, and pivotally disposed at the keyboard base body;
a free end portion, having a second matching surface; and
a panel surface, disposed between the connection end portion and the free end portion, where

when the free end portion moves from the flexible rollable panel arrangement area to the key arrangement area, the second matching surface of the free end portion sequentially abuts against the first matching surfaces of the key caps, so that each of the first matching surface is pressed downwards because each of the first matching surface is subjected to a downward vertical component from the second matching surface, thereby unfolding the panel surface above the keys.

In a preferred embodiment, each of the first matching surfaces is an inclined surface or a chamfered surface, and the second matching surface is an inclined surface or a chamfered surface.

In a preferred embodiment, the keyboard with a key accommodation function further includes a positioning element, where the connection end portion of the flexible rollable panel is located at one side of the key arrangement area, and the positioning element is located at the other side, opposite to the one side, of the key arrangement area.

In a preferred embodiment, the positioning element has a first magnetic element; the free end portion has a second magnetic element; and when the free end portion approaches the positioning element, the second magnetic element attracts the first magnetic element.

In a preferred embodiment, the positioning element has a first hook element; the free end portion has a second hook element; and when the free end portion approaches the positioning element, the second hook element hooks the first hook element.

In a preferred embodiment, the key with a key accommodation function further includes: two chutes, disposed at a front side and a rear side of the key arrangement area, where the free end portion slides left and right from the flexible rollable panel arrangement area to the key arrangement area along the two chutes.

In a preferred embodiment, the panel surface is a drawing tablet, a handwriting tablet, a touchpad, a wireless charging pad, or a combination thereof.

In a preferred embodiment, the keyboard with a key accommodation function further includes a display screen, where the display screen is pivotally disposed at the keyboard base body; when the panel surface is unfolded to press the keys downwards for the display screen being closed towards the keyboard base body, a display surface of the display screen is near the keyboard base body.

### BRIEF DESCRIPTION OF THE DRAWINGS

FIG. 1 is a three-dimensional schematic diagram illustrating a keyboard with a key accommodation function according to the present invention when a plurality of keys is not accommodated;

FIG. 2 is a schematic diagram illustrating a partial side surface of a key of the keyboard with a key accommodation function according to the present invention when the key is not pressed;

FIG. 3 is a schematic side view illustrating the key of the keyboard with a key accommodation function according to the present invention when the key is pressed;

FIG. 4 is a three-dimensional schematic diagram illustrating the keyboard with a key accommodation function according to the present invention when a plurality of keys is accommodated; and

FIG. 5 is a three-dimensional schematic diagram illustrating the keyboard with a key accommodation function according to the present invention when a display screen is closed to a keyboard base body.

### DETAILED DESCRIPTION OF THE PREFERRED EMBODIMENTS

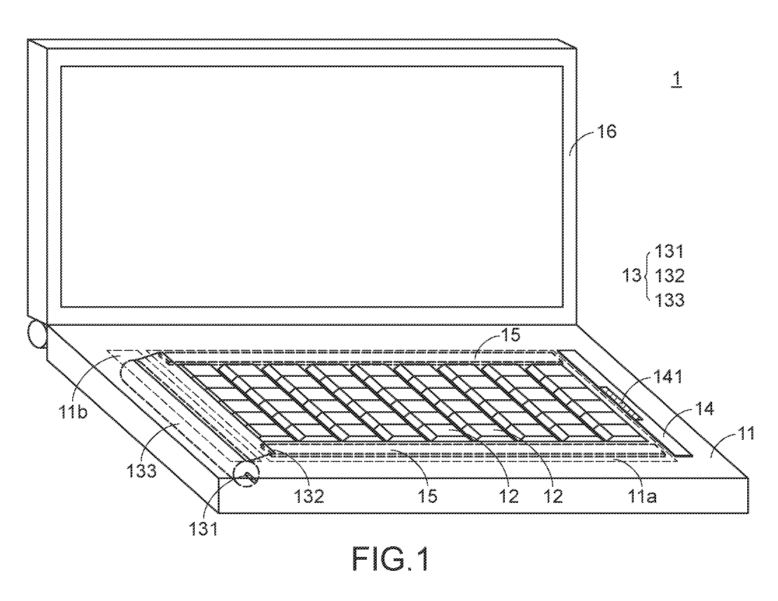

Referring to FIG. 1, FIG. 1 is a three-dimensional schematic diagram illustrating a keyboard with a key accommodation function according to the present invention when a plurality of keys is not accommodated. A keyboard 1 with a key accommodation function of the present invention includes a keyboard base body 11, a plurality of keys 12, and a flexible rollable panel 13. Both of the keys 12 and the flexible rollable panel 13 are disposed at the keyboard base body 11, so as to be operated by a user. The keyboard base body 11 has a key arrangement area 11a and a flexible rollable panel arrangement area 11b, and the key arrangement area 11a is adjacent to the flexible rollable panel arrangement area 11b. The keys 12 are disposed in the key arrangement area 11a, and the flexible rollable panel 13 is disposed in the flexible rollable panel arrangement area 11b. That is, the flexible rollable panel 13 and the plurality of keys 12 are adjacently arranged.

Further, the flexible rollable panel 13 includes a connection end portion 131, a free end portion 132, and a panel surface 133. A left side and a right side of the panel surface 133 are respectively connected to the connection end portion 131 and the free end portion 132. The panel surface 133 is extended with the movement of the free end portion 132. The connection end portion 131 is pivotally disposed at the flexible rollable panel arrangement area 11b of the keyboard base body 11. The free end portion 132 may be driven by an external force, so as to move towards the plurality of keys 12 in the key arrangement area 11a, and enable the panel surface 133 to be extended with the movement of the free end portion 132.

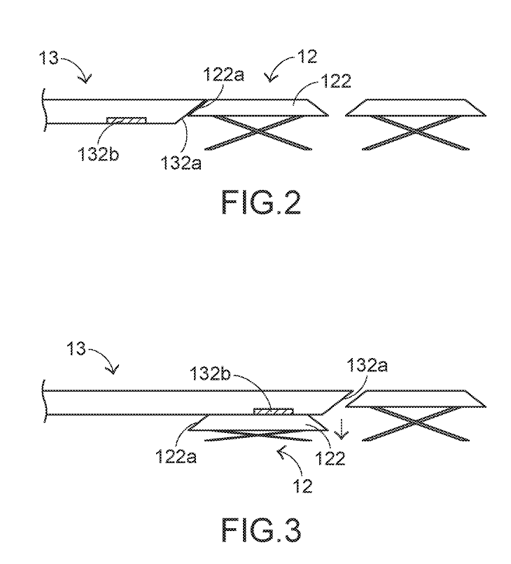

Referring to FIG. 1 to FIG. 3 in combination, FIG. 2 is a schematic diagram illustrating a partial side surface of a key of the keyboard with a key accommodation function according to the present invention when the key is not pressed, and FIG. 3 is a schematic side view illustrating the key of the keyboard with a key accommodation function according to the present invention when the key is pressed. Specifically, to enable the keys 12 of the present invention to be pressed downwards by the flexible rollable panel 13, a key cap 122 of each of the keys 12 has a first matching surface 122a, the first matching surface 122a is formed at a top edge of the key cap 122, and the free end portion 132 of the flexible rollable panel 13 has a second matching surface 132a. When the free end portion 132 approaches towards the key arrangement area 11a (that is, approaches towards the keys 12) from the flexible rollable panel arrangement area 11b, the second matching surface 132a abuts against a first matching surface 122a (as shown in FIG. 2), and with the continuous movement of the free end portion 132, a key 12 is pressed downwards because the first matching surface 122a is subjected to a downward vertical component from the second matching surface 132a (as shown in FIG. 3). Based on the principle, the free end portion 132 continues moving towards the right, so as to press the remaining keys 12 downwards one by one. By means of this arrangement, the panel surface 133 is unfolded above the plurality of keys 12, so as to achieve an effect of accommodating the keys 12.

It is particularly illustrated herein that, with regard to a first matching surface 122a of each key cap 122 and the second matching surface 132a of the free end portion 132 of the present invention, to enable the key cap 122 to move downwards due to a force that is applied when the free end portion 132 abuts against the key cap 122, a preferred implementation aspect of the present invention is that the first matching surface 122a is an inclined surface with a surface inclined upwards, and the second matching surface 132a is an inclined surface with a surface inclined downwards. Therefore, when the second matching surface 132a abuts against the first matching surface 122a, the second matching surface 132a may apply a downward component to the first matching surface 122a. Alternatively, the arrangement may be changed as an arrangement that the first matching surface 122a and the second matching surface 132a are chamfered surfaces. Alternatively, the first matching surface 122a and the second matching surface 132a are an inclined surface and a chamfered surface respectively. Matching surface structures shall all fall within the application scope of the present invention as long as the first matching surface 122a is subjected to a force and is pressed downwards when the first matching surface 122a abuts against the second matching surface 132a.

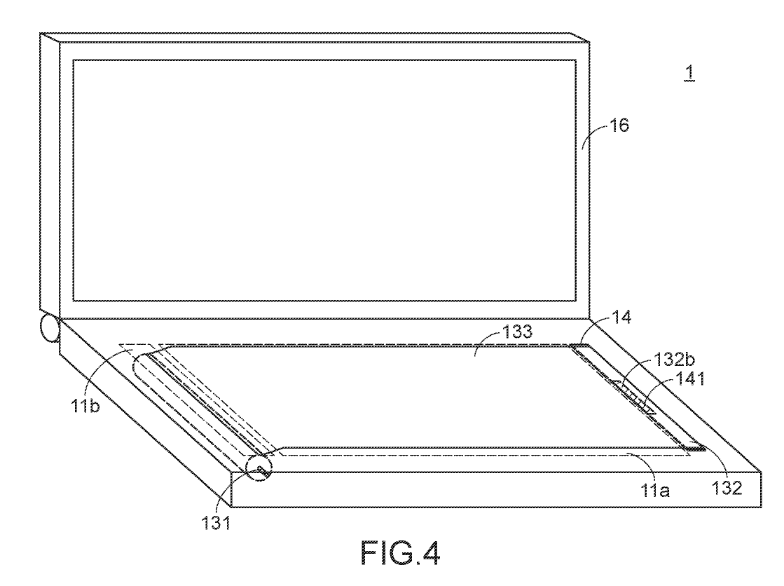

Referring to FIG. 1 to FIG. 4 in combination, FIG. 4 is a three-dimensional schematic diagram illustrating the keyboard with a key accommodation function according to the present invention when a plurality of keys is accommodated. The keyboard 1 with a key accommodation function of the present invention further includes a positioning element 14. The positioning element 14 and the connection end portion 131 of the flexible rollable panel 13 are respectively disposed at a left side and a right side of the key arrangement area 11a. An objective of arranging the positioning element 14 is that, when the panel surface 133 is unfolded above the plurality of keys 12, the panel surface 133 is positioned by joining the free end portion 132 and the positioning element 14. For example, a joining manner is that, the positioning element 14 has a first magnetic element 141, the free end portion 132 has a second magnetic element 132b, and when the free end portion 132 approaches the positioning element 14, the second magnetic element 132b attracts the first magnetic element 141. Besides, using hook elements to replace the magnetic elements is also a feasible structure arrangement.

In another aspect, to enable the panel surface 133 of the flexible rollable panel 13 of the present invention to be laterally unfolded along a predetermined horizontal height, the keyboard 1 with a key accommodation function further includes two chutes 15, disposed at a front side and a rear side of the key arrangement area 11a, so that the free end portion 132 and the panel surface 133 slide from left to right along the two chutes 15, thereby unfolding the panel surface 133.

Besides, the unfolded panel surface 133 presses the keys 12 downwards as well as functions as a functional panel surface. An objective is that, in a case in which a user doesn't need to use the keys 12 for the moment, the functional panel surface may be unfolded, so that the user may use more diverse functions. For example, the functional panel surface is a drawing tablet, a handwriting tablet, a touchpad, a wireless charging pad, or a combination thereof, so that the keyboard with a key accommodation function of the present invention presents multi-functional usages.

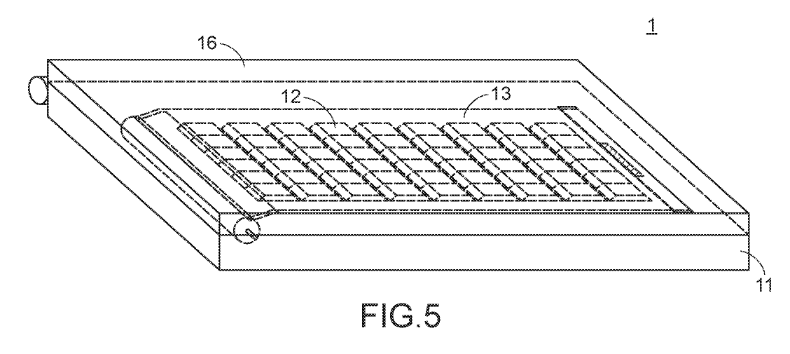

Referring to FIG. 1 to FIG. 5 in combination, FIG. 5 illustrates the keyboard with a key accommodation function according to the present invention when a display screen is closed to a keyboard base body. If the keyboard 1 with a key accommodation function of the present invention is applied to a concept of a notebook computer, the keyboard 1 with a key accommodation function of the present invention further includes a display screen 16, and the display screen 16 is pivotally disposed at the keyboard base body 11. The plurality of keys 12 disposed on the keyboard base body 11 may be pressed downwards by the flexible rollable panel 13, and a part of space occupied by the plurality of keys 12 can be vacated. Therefore, when a display surface of the display screen 16 is closed towards the keyboard base body 11, the display screen 16 may further move to the part of space that is originally occupied by the keys 12, so as to effectively configure the space and thin the whole apparatus.

To sum up, with the keyboard with a key accommodation function of the present invention, a flexible rollable panel is used to press keys towards a keyboard base body and to enable the keys to retain pressed states, so that the keys are accommodated in the keyboard base body, and a display screen may be closely closed to the keyboard base body. In addition, the flexible rollable panel is functional, so as to enable the keyboard with a key accommodation function of the present invention to have more operating performances.

The foregoing embodiments are merely intended to exemplarily describe the principle and effects of the present invention and illustrate the technical features of the present invention, but are not intended to limit the protection scope of the present invention. Modifications or equivalent arrangements that may be easily accomplished by a person skilled in the art without departing from the technical principle and spirit of the present invention shall fall within the claimed scope of the present invention. Therefore, the protection scope of the claims of the present invention shall be subjected to the claims described below.

What is claimed is:

1. A keyboard with a key accommodation function, comprising:
a keyboard base body, having a key arrangement area and a flexible rollable panel arrangement area, wherein the key arrangement area is adjacent to the flexible rollable panel arrangement area;
a plurality of keys, disposed in the key arrangement area, wherein each of the keys has a key cap, and a top edge of each key cap has a first matching surface; and
a flexible rollable panel, comprising:
a connection end portion, located at the flexible rollable panel arrangement area, and pivotally disposed at the keyboard base body;
a free end portion, having a second matching surface; and
a panel surface, disposed between the connection end portion and the free end portion, wherein
when the free end portion moves from the flexible rollable panel arrangement area to the key arrangement area, the second matching surface of the free end portion sequentially abuts against the first matching surfaces of the key caps, so that each of the first matching surface is pressed downwards because each of the first matching surface is subjected to a downward vertical component from the second matching surface, and the panel surface is unfolded above the keys.

2. The keyboard with a key accommodation function according to claim 1, wherein each of the first matching surfaces is an inclined surface or a chamfered surface, and the second matching surface is an inclined surface or a chamfered surface.

3. The keyboard with a key accommodation function according to claim 2, further comprising: a positioning element, wherein the connection end portion of the flexible rollable panel is located at one side of the key arrangement area, and the positioning element is located at the other side, opposite to the one side, of the key arrangement area.

4. The keyboard with a key accommodation function according to claim 3, wherein the positioning element has a first magnetic element; the free end portion has a second magnetic element; and when the free end portion approaches the positioning element, the second magnetic element attracts the first magnetic element.

5. The keyboard with a key accommodation function according to claim 3, wherein the positioning element has a first hook element; the free end portion has a second hook element; and when the free end portion approaches the positioning element, the second hook element hooks the first hook element.

6. The keyboard with a key accommodation function according to claim 1, further comprising: two chutes, disposed at a front side and a rear side of the key arrangement area, wherein the free end portion slides left and right from the flexible rollable panel arrangement area to the key arrangement area along the two chutes.

7. The keyboard with a key accommodation function according to claim 1, wherein the panel surface is a drawing tablet, a handwriting tablet, a touchpad, a wireless charging pad, or a combination thereof.

8. The keyboard with a key accommodation function according to claim 1, further comprising: a display screen, wherein the display screen is pivotally disposed at the keyboard base body; when the panel surface is unfolded to press the keys downwards for the display screen being closed towards the keyboard base body, a display surface of the display screen is near the keyboard base body.
